(19) United States
(12) Patent Application Publication
(10) Pub. No.: US 2009/0061966 A1
(43) Pub. Date: Mar. 5, 2009

(54) ANTENNA AND SPEAKER ASSEMBLY

(75) Inventors: Guangli Yang, Waukegan, IL (US); Hongwei Liu, South Elgin, IL (US); Adrian Napoles, Lake Villa, IL (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/850,467

(22) Filed: Sep. 5, 2007

(51) Int. Cl. H04M 1/00

(52) U.S. Cl. 455/575.7

(57) ABSTRACT

A portable communication device (100) for reception of communication signals and a method (500) for tuning an antenna assembly (132) of the portable communication device (100) are provided. The antenna assembly (132) includes an antenna element (136) and a speaker assembly (124) with a metal element. The antenna element (136) is coupleable to the metal element of the speaker assembly (132) to provide increased metallization for generation of an antenna length for reception of desired communication signals. The method (500) for tuning the antenna assembly includes coupling (508) the antenna element (136) to the metal element of the speaker assembly (124), thereby providing the increased metallization to tune the antenna length of the antenna assembly (132) for reception of the communication signals within a predetermined frequency range.

### FIELD OF THE INVENTION

The present invention generally relates to portable communications devices having a foldable form factor, and more particularly relates to antennas for portable foldable (or clamshell form factor) communications devices.

### BACKGROUND OF THE DISCLOSURE

Portable communication devices, such as cellular phones come in several different form factors. One common form factor is the “clamshell” or foldable form factor which has a base housing coupled to a moveable housing by one or more hinges. In a clamshell orientation, the base is sometimes called a “lower clam” and the moveable portion called a “flip.” While a foldable phone provides an ergonomic form factor, antenna design is problematic, particularly for internal antenna elements such as Global Positioning System (GPS) antennas. An essential antenna design issue is that reception and transmission of radio frequency (RF) signals from antenna elements should be above a threshold quality level in both the open and closed phone positions. Antenna design becomes more problematic in slim, foldable form factors which require extremely thin (e.g., 7 mm or less) base and/or moveable housing portions.

Thus, what is needed is an antenna design for slim, foldable phones that provides robust RF reception in both an open phone position and a closed phone position. Furthermore, other desirable features and characteristics will become apparent from the subsequent detailed description and the appended claims, taken in conjunction with the accompanying drawings and this background of the disclosure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is a block diagram of a portable communication device in accordance with the present embodiment;

FIG. 2 is a top left front view of a clamshell-style portable communication device in an opened position in accordance with the present embodiment;

FIG. 3 is a bottom right rear view of the clamshell-style portable communication device of FIG. 2 in a closed position in accordance with the present embodiment;

FIG. 4 is an exploded view of a speaker assembly in accordance with the present embodiment;

FIG. 5 is a flow chart of an antenna assembly tuning method in accordance with the present embodiment;

FIG. 6 is a first measured return loss graph of the antenna assembly wherein the portable communication device in accordance with the present embodiment is in free space and in the closed position of FIG. 3;

FIG. 7 is a second measured return loss graph of the antenna assembly wherein the portable communication device in accordance with the present embodiment is in free space and in the opened position of FIG. 2;

FIG. 8 is a first measurement of the antenna assembly radiation pattern wherein the portable communication device in accordance with the present embodiment is in free space and in the closed position of FIG. 3;

FIG. 9 is a second measurement of the antenna assembly radiation pattern wherein the portable communication device in accordance with the present embodiment is in free space and in the opened position of FIG. 2;

FIG. 10 is a third measurement of the antenna assembly radiation pattern wherein the portable communication device in accordance with the present embodiment is handheld and in the closed position of FIG. 3; and

FIG. 11 is a fourth measurement of the antenna assembly radiation pattern wherein the portable communication device in accordance with the present embodiment is handheld and in the opened position of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to antenna systems. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

According to the Detailed Description, an antenna assembly is provided for reception of communication signals. The antenna assembly includes a first antenna element coupled to a metallic second antenna element, where the second antenna element includes at least a portion of a speaker assembly.

Further, a portable communication device is provided for reception of desired communication signals. The portable communication device includes an antenna element and a speaker assembly with a metallic portion. The antenna element is coupled to the speaker assembly to provide increased metallization for generation of an antenna electrical length appropriate for reception of desired communication signals.

In addition, a method is provided for tuning an antenna assembly that includes a first antenna element coupleable to a second antenna element, the second antenna element including at least a metal element of a speaker assembly. The method includes the step of coupling the first antenna element to the metal element of the speaker assembly to provide increased metallization for tuning of an antenna electrical length of the antenna assembly for reception of communication signals within a predetermined frequency range.

The following detailed description of the invention is merely exemplary in nature and is not intended to limit the invention or the application and uses of the invention. Furthermore, there is no intention to be bound by any theory presented in the preceding background of the invention or the following detailed description of the invention.

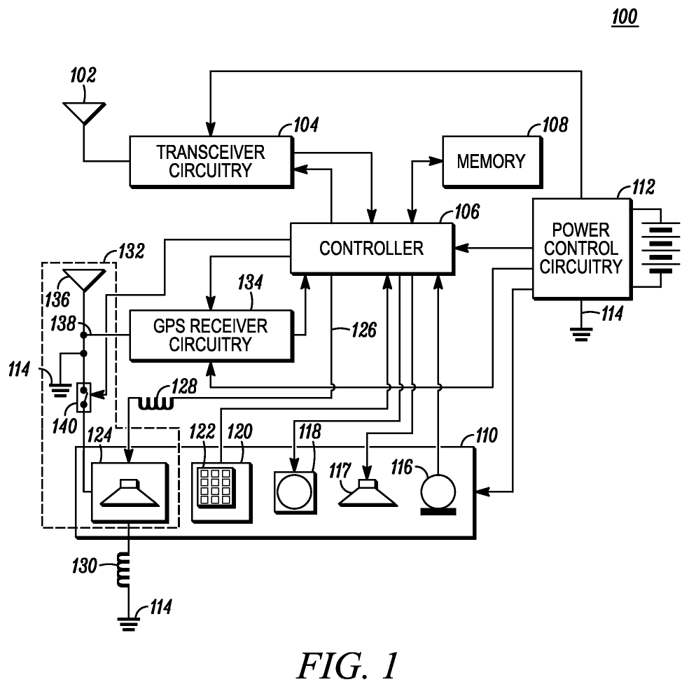

FIG. 1 depicts a block diagram of a portable communication device 100, such as a cellular telephone, in accordance with an embodiment of the present invention. Although the portable communication device 100 is depicted as a cellular telephone, the portable communication device can be implemented as a pager, a laptop computer with a wireless connection, a personal digital assistant with wireless connection, a navigational device used to receive signals from satellites, or the like. The portable communication device 100 includes a first antenna assembly 102 for receiving and transmitting radio frequency (RF) signals, such as cellular, WiFi, or WiMAX signals. Transceiver circuitry 104 includes receiver circuitry and transmitter circuitry in a manner familiar to those skilled in the art. The receiver circuitry demodulates and decodes the RF signals to derive information and is coupled to a controller 106 for use in accordance with the function(s) of the portable communication device 100.

The controller 106 also provides information to the transmitter circuitry of the transceiver circuitry 104 for encoding and modulating information into RF signals for transmission from the first antenna assembly 102. As is well-known in the art, the controller 106 is typically coupled to a memory device 108 and a user interface 110 to perform the functions of the portable communication device 100. Power control circuitry 112 generates and provides appropriate operational voltage and current to, and defines a ground plane 114 for, components of the portable communication device 100, such as the controller 106, the transceiver circuitry 104, and/or the user interface 110. In this embodiment, the user interface 110 includes a microphone 116, an earpiece speaker 117, a display 118, and one or more key inputs 120, including, for example, a keypad 122. In accordance with the present embodiment, the user interface 110 also includes a loudspeaker assembly 124 coupled to an audio feed 126 from the controller 106 by a first choke 128 and coupled to the ground plane 114 by a second choke 130, where the loudspeaker assembly 124 is a speaker assembly which provides presentation of audio to a user during speakerphone operation of the portable communication device 100 and, accordingly, the controller 106 provides audio signals on audio feed 126 during such speakerphone operation. The first choke 128 and the second choke 130 provide RF isolation for the loudspeaker assembly 124 from the audio feed 126 and the ground plane 114, respectively.

In addition, in accordance with the present embodiment, the portable communication device 100 also includes a second antenna assembly 132 coupled to Global Positioning System (GPS) receiver circuitry 134 which operates under the control of the controller 106 and receives operational voltage and current from the power control circuitry 112. The GPS receiver circuitry 134 demodulates and decodes GPS signals received by the second antenna assembly 132. GPS signals typically have a frequency in the range of 1200 to 1600 MHz, with primary GPS traffic utilized for positional determination transmitted at 1575.42 MHz.

In accordance with the present embodiment, the second antenna assembly 132 includes a first antenna element 136 connected at a feed point 138 to the GPS receiver circuitry 134 and connected to the ground plane 114. The second antenna assembly 132 also includes a second antenna element coupled to or coupleable to the first antenna element 136, the second antenna element including at least a metallic portion of the loudspeaker assembly 124. In accordance with the present embodiment, the first antenna element 136 is coupled to the metal element of the loudspeaker assembly 124 to provide increased metallization to the second antenna assembly 132 for generation of an antenna electrical length for reception of the GPS signals. The first antenna element 136 could be either capacitively coupleable to the second antenna element, pressure connectable to the second antenna element, integrally formed with the second antenna element, or use other methods for coupling. Connection of the first antenna element 136 to the metal element of the loudspeaker assembly 124 does not interfere with the generation of audio signals by the loudspeaker assembly 124 because audio signals audible to a user of the portable communication device 100 are generated in the kilohertz range while RF communication signals received by the first antenna element 136 for GPS signals are around 1575 MHz.

The first antenna element 136 may be coupleable to the metal element of the loudspeaker assembly 124 to allow the antenna assembly 132 to be tunable for robust reception of the GPS signals by either electrically, magnetically, or mechanically bringing the first antenna element 136 into contact with the second antenna element. In one implementation option, a switch 140 (shown in dotted line) electrically couples the first antenna element 136 to the second antenna element in response to a signal from the controller 106. In this configuration, the first antenna element 136 is connected to a first pole of the switch 140, and the metal element of the loudspeaker assembly 124 (i.e., the second antenna element) is connected to a second pole of the switch 140. By the controller 106 signaling the switch 140 to close or open, the second antenna assembly 132 can be tuned for robust reception of the GPS signals by coupling the first antenna element 136 to, or uncoupling the first antenna element 136 from, the second antenna element.

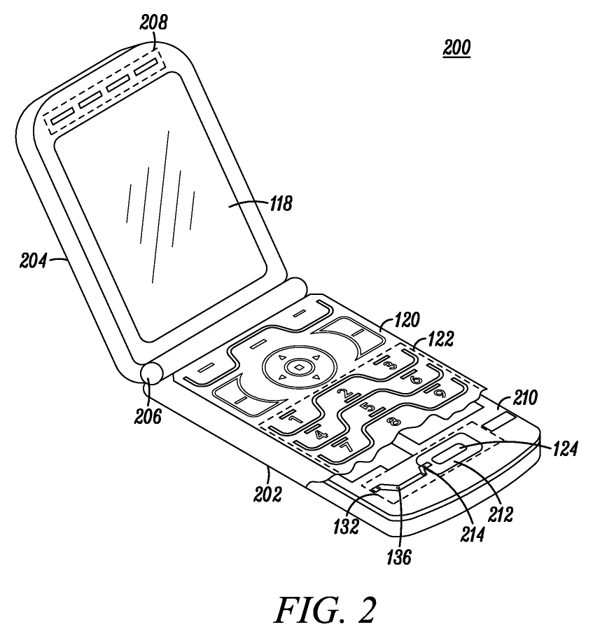

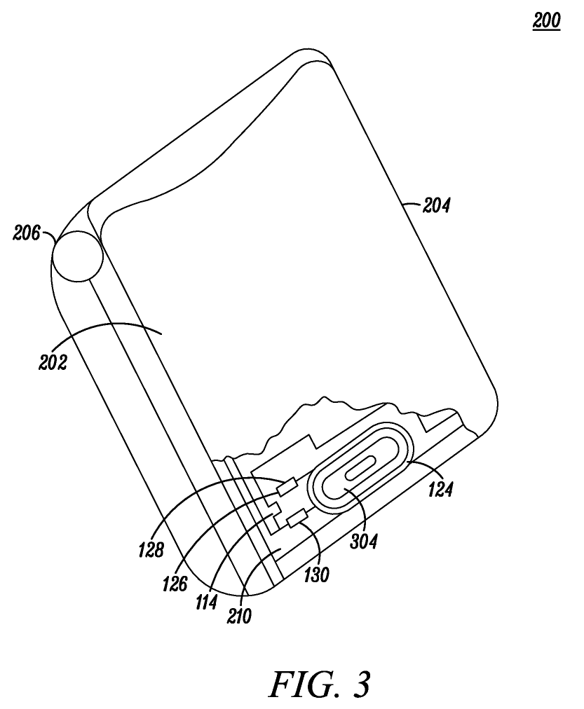

Referring to FIGS. 2 and 3, a portable communication device 200 in accordance with the present embodiment is depicted having a foldable or clamshell form factor. The portable communication device 200 includes a first housing portion 202, sometimes called a base or a lower clam portion, and a second housing portion 204, also referred to as an upper flip or moveable portion. A hinge element 206, including one or more hinges, couples the moveable housing portion 204 to the first housing portion 202 while allowing for movement of the second housing portion 204 in relation to the base housing portion 202. With this hinged movement, the portable communication device 200 can assume an open position (e.g., as shown in FIG. 2) and a closed position (e.g., as shown in FIG. 3).

FIG. 2 depicts a top left front view of the portable communication device 200 in the open position. In this embodiment, a display 118 is provided on the inside surface of the second housing portion 204 for presentation of information to the user when the portable communication device 200 is open. Openings 208 in the upper inside surface of the second housing portion 204 allow sound to be provided to the user from the earpiece speaker 117 (shown in FIG. 1).

Several key inputs 120, including the keypad 122, are provided on an inner surface of the base housing portion 202. The bottom section of the base housing portion 202, including the bottom of the keypad 122, is cutaway to reveal an enclosed printed circuit board 210. As shown, the loudspeaker assembly 124 is mounted to the printed circuit board 210. In this cutaway view, the rear portion of the loudspeaker assembly 124 is visible with a metal element 212, such as a metal portion of the loudspeaker assembly housing, on the rear surface of the loudspeaker assembly 124.

The first antenna element 136 of the second antenna assembly 132 (shown in FIG. 1) is a monopole antenna element (such as the inverted-L antenna element depicted in FIG. 2) and is also mounted on the printed circuit board 210. The antenna element 136 may be integrally formed with or may be, as depicted in FIG. 2, connectable to the metal element 212 of the loudspeaker assembly 124, thereby providing increased metallization to the GPS antenna assembly 132 for generation of an increased antenna electrical length for reception of the GPS signals.

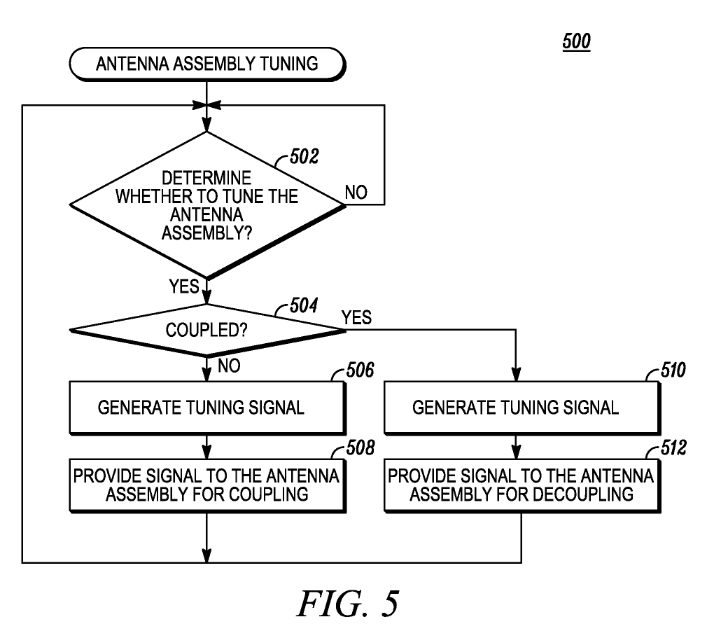

Having the first antenna element 136 connectable to the metal element 212 of the loudspeaker assembly 124 allows for tuning of the GPS antenna assembly 132. Tuning can be performed in the factory or can be performed by the portable communication device 200 to improve GPS signal reception as discussed in more detail in regards to FIG. 5.

While the block diagram of FIG. 1 shows an optional switch 140 for tuning the second antenna assembly 132, the cutaway view of FIG. 2 depicts another method of connectivity where the first antenna element 136 has a portion forming a clip portion 214 over the loudspeaker assembly 124 for connection to the metal element 212. The clip portion 214 can be connected to the loudspeaker assembly 124 by pressure connection. As an example of a pressure connection is when the base housing portion 202 (or a non-conductive “bump” attached to the base housing portion 202) contacts the clip portion 214 and, when the printed circuit board 210 with the antenna element 136 and the loudspeaker assembly 124 mounted is enclosed inside the base housing portion 202, the base housing portion 202 places pressure on the clip portion 214 so that it contacts with the metal element 212. Alternately, a magnetic connection (e.g., where the loudspeaker assembly 124 can activate an electromagnetic field to bring the clip portion 214 into contact with the metal element 212) can connect the clip portion 214 to the loudspeaker assembly 124.

FIG. 3 depicts a bottom right rear view of the portable communication device 200 in the closed position where the flip has been rotatably folded over the lower clam and the portable communication device 200 has been rotated so that the cutaway portion exposing the speaker assembly 136 is readily viewable. A power cord port 302 is depicted in the base housing portion 202 and provides a connection to a battery internal to the portable communication device 200 for charging of a battery. The cutaway portion of FIG. 3 shows the loudspeaker assembly 124 having a diaphragm 304 for generating audio signals during speakerphone operation of the portable communication device 200. The loudspeaker assembly 124 couples to the audio feed 126 via the first choke 128 and couples to the ground plane 114 of the portable communication device 200 via the second choke 130. The first choke 128 and second choke 130 are mounted on the printed circuit board 210.

Locating the first antenna element 136 (shown in FIGS. 1 and 2) so that the clip portion 214 (FIG. 2) is proximate to the diaphragm 304 of the loudspeaker assembly 124 allows the clip portion 214 to be pressure connected to the loudspeaker assembly 124 by activation of the loudspeaker assembly 124 in a predetermined manner to cause the diaphragm 304 to deflect the clip portion 214 of the antenna element 136 to place the clip portion 214 in contact with a metal element of the loudspeaker assembly 124. Alternately, the diaphragm 304 may include metallization and the clip portion 214 could contact a metal portion of the diaphragm 304 when the diaphragm is activated in a predetermined manner to increase metallization of the second antenna assembly 132.

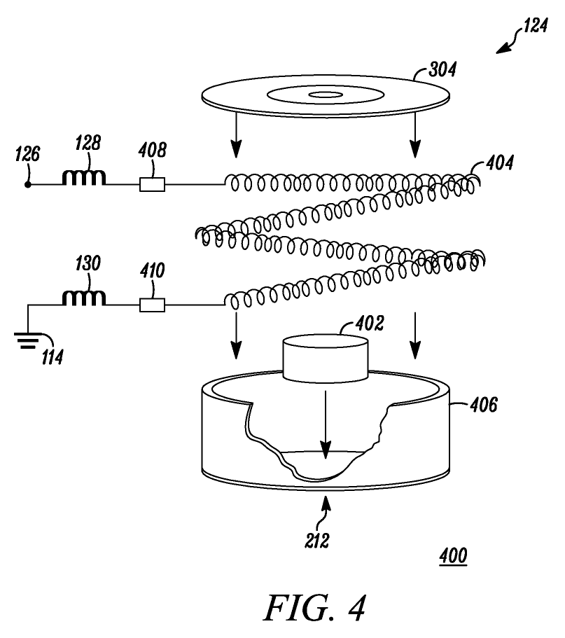

Referring to FIG. 4, an exploded view 400 of the loudspeaker assembly 124 shows a stationary magnet 402, a coil 404, the diaphragm 304, and a housing or frame 406, including, for example, the metal element 212 on a base or rear surface of the frame 406. The arrows show how the loudspeaker assembly 124 elements fit inside of the frame 406. The stationary magnet 402 is typically a magnetic element composed of, for example, ferrite or neodymium and affixed to the frame 406. The diaphragm 304 is typically fabricated from lightweight, high stiffness to mass ratio material, such as cellulose, polymer, carbon or metal. The stationary magnet 402 sets up a static magnetic field, and the diaphragm 304 is attached to the coil 404. Thus, the coil 404 is immersed in the static magnetic field of the stationary magnet 402. The diaphragm 304 is actuated by the attached coil 404 when a current is passed through the coil 404. The alternating magnetic field produced by the current flowing through the coil 404 reacts against the static magnetic field generated by the stationary magnet 402 causing the coil 404 and the attached diaphragm 304 to move air, thus producing sound.

The coil 404 is typically a coil of fine wire constrained within the frame 406 to wrap axially through a cylindrical magnetic gap within the frame 406 between the stationary magnet 402 and the frame 406. When current is applied to the coil 404, an electromagnetic field is created; and the coil 404 and the stationary magnet 402 interact, generating a mechanical force which causes the coil 404 and the attached diaphragm 304 to move back and forth to produce sound under the control of the audio feed 126 signal coming from the controller 106 (FIG. 1). The audio feed 126 is connected to one end of the coil 404 via the first choke 128 and a first loudspeaker assembly contact 408. The ground plane 114 is connected to the other end of the coil 404 via the second choke 130 and a second loudspeaker assembly contact 410.

In accordance with the present embodiment, the second antenna assembly 132 has an increased metallization for generation of an antenna electrical length for GPS signal reception. The increased metallization is achieved by connecting the first antenna element 136 (FIGS. 1 and 2) to a metal element of the loudspeaker assembly 124. The metal element could be the coil 404, the diaphragm 304, the frame 406, either of the contacts 408, 410, or any portion of the coil 404, the diaphragm 304, or the frame 406. As seen in FIG. 1, a switch 140 operating under the control of the controller 106 may be used to connect the metal element of the loudspeaker assembly 124 (e.g., the metal element 212 on the base portion or rear surface of the frame 406) to the antenna element 136. Alternately, the electromagnetic field generated by the current flowing through the coil 404 may operatively deflect a clip portion 214 (FIG. 2) of the first antenna element 136 to connect the clip portion 214 to the metal element of the loudspeaker assembly 124 and provide increased metallization for tuning of the antenna assembly 132. Further, the clip portion 214 may be located relative to the diaphragm 304 such that deflection of the diaphragm 304 to a fixed position connects a metal element of the diaphragm 304 to provide the increased metallization for tuning of the antenna assembly 132. The diaphragm 304 can be deflectable to the fixed position in response to either the electromagnetic force generated by the coil 404 or an electrostatic force generated by the loudspeaker assembly 124.

In accordance with the present embodiment, the second antenna assembly 132 can be factory tuned by, for example, integrally forming the monopole antenna element 136 with a metal element of the loudspeaker assembly 124 or pressure connecting the antenna element 136 to the metal element when the antenna assembly is enclosed within the base housing portion 202. Alternately, the controller 106 can tune the antenna assembly.

Referring to FIG. 5, a flowchart 500 illustrates an exemplary method for tuning the second antenna assembly 132 in accordance with the present embodiment by providing increased metallization for the second antenna assembly 132 under the control of the controller 106. The method for tuning the second antenna assembly 132 begins by the controller 106 determining 502 whether to tune the second antenna assembly 132. In accordance with the present embodiment, the controller 106 could determine to tune the GPS antenna assembly 132 whenever the GPS receiver circuitry 134 is activated. Alternatively, the controller 106 could determine to tune the second antenna assembly 132 in response to the GPS signal quality by monitoring the signal quality (e.g., monitoring the signal-to-noise ratio) of the GPS signals received from the GPS receiver circuitry 134. When the signal quality falls below a predetermined quality level, the controller 106 determines to tune the antenna assembly 132.

If the controller 106 determines 504 that the antenna element 136 is not coupled to the metal element of the loudspeaker assembly 124, the controller 106 generates 506 an antenna assembly tuning signal for coupling the antenna element 136 to the metal element. The antenna assembly tuning signal is then provided 508 to the antenna assembly 132 to couple the antenna element 136 to the metal element of the loudspeaker assembly 124 to provide increased metallization for varying an antenna (electrical) length to tune the antenna assembly 132 for reception of communication signals within a predetermined frequency range.

As discussed in accordance with FIG. 1, the second antenna assembly 132 may include the switch 140. At step 508, the controller 106 would provide the antenna assembly tuning signal to the switch 140 to close the switch to couple the antenna element 136 to the metal element of the loudspeaker assembly 124. Alternately, the electromagnetic field of the loudspeaker assembly 124 may be used to couple the clip portion 214 of the antenna element 136 to the metal element of the loudspeaker assembly 124; the controller 106 would provide the antenna assembly tuning signal to the coil 404 of the loudspeaker assembly 124 to generate the an electromagnetic field to deflect the clip portion 214 of the antenna element 136 to connect the clip portion 214 to the metal element for tuning of the antenna assembly 132. Yet another method of tuning the antenna assembly 132 in accordance with the present embodiment could include the controller 106 coupling the antenna element 136 to a metal element of the diaphragm 304 by providing a predetermined antenna tune signal to the loudspeaker assembly 124 to deflect the diaphragm 304 to a predetermined position for pressure connecting the clip portion 214 of the antenna element 136 to the metal element of the diaphragm 304.

If the controller 106 determines 504 that the antenna element 136 is coupled to the metal element of the loudspeaker assembly 124, the controller 106 generates 510 an antenna assembly tuning signal for decoupling the antenna element 136 from the metal element. The antenna assembly tuning signal is then provided 512 to the antenna assembly 132 to decouple the antenna element 136 from the metal element of the loudspeaker assembly 124 (e.g., opening the switch 140) to vary the antenna length for tuning of the antenna assembly 132. After providing 508, 512 the antenna tuning signal to the antenna assembly 132, processing returns to await the next determination 502 to tune the antenna assembly 132.

Thus, the second antenna assembly 132 can be tuned by the controller by, for example, generating and providing an antenna tuning signal to the GPS antenna assembly 132 in response to a quality measurement of the GPS signals. Alternatively, the antenna tuning signal can be generated by the controller 106 and provided to the antenna assembly 132 whenever the GPS receiver is activated. Preferably, antenna tuning signals provided to the loudspeaker assembly for tuning of the antenna assembly 132 are predetermined antenna tuning signals that will not generate sound within the audible human frequency range.

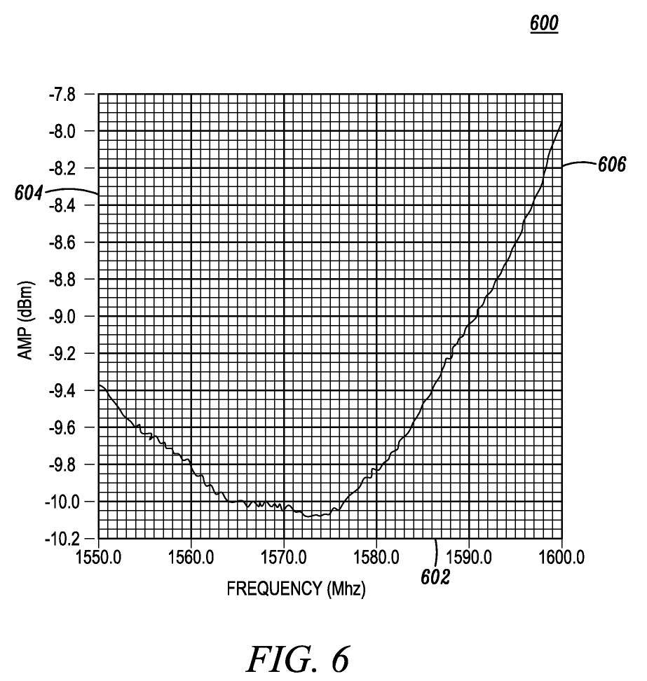

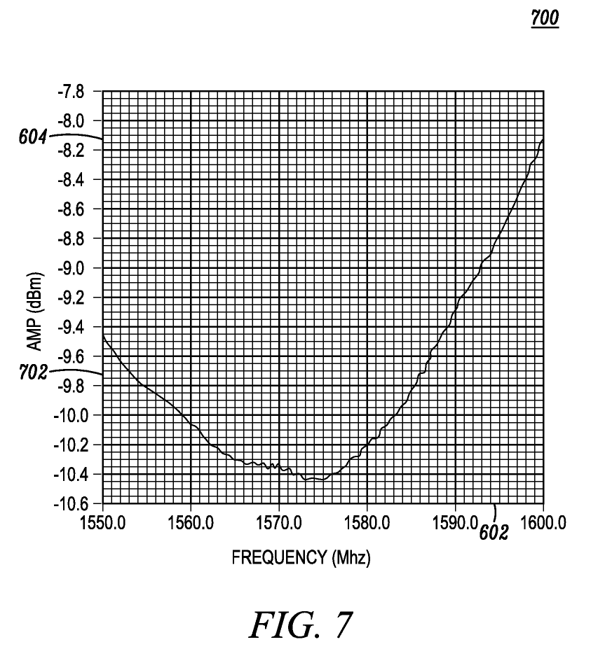

FIGS. 6 and 7 depict measured return loss graphs for performance of the second antenna assembly 132 in accordance with the present GPS embodiment, where frequency (in MHz) is plotted on the abscissa (i.e., the x-axis) 602 and return loss (in negative dBm) is plotted on the ordinate (i.e., the y-axis) 604. The return loss graph 600 shown in FIG. 6 depicts the measured return loss 606 of the GPS antenna assembly 132 when the portable communication device 200 is operating in the closed position (i.e., as shown in FIG. 3) in free space (i.e., when not surrounded by anything such as a user's hand). The return loss graph 700 shown in FIG. 7 depicts the return loss 702 of the GPS antenna assembly 132 when the portable communication device 200 is operating in the open position (i.e., as shown in FIG. 2) in free space. It can be seen from a review of graphs 600 and 700 that the housing position (i.e., either opened or closed) of the portable communication device 200 has very little effect on the reception of the GPS antenna assembly 132 and, in both positions, the optimal reception frequencies (i.e., the lowest return loss 606, 702 of the antenna assembly 132) is tuned to center around the GPS operational frequency, 1575.42 MHz.

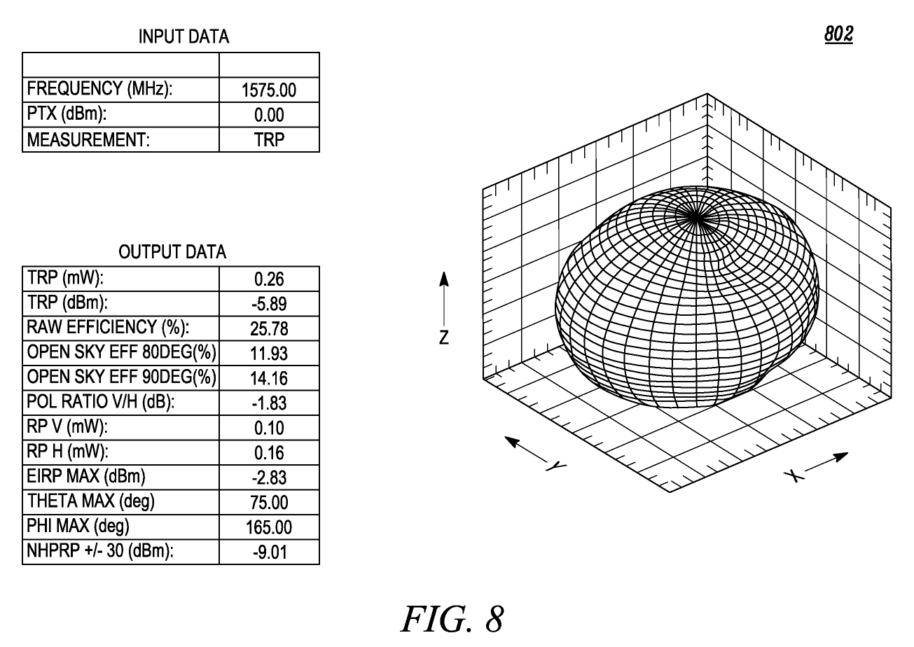

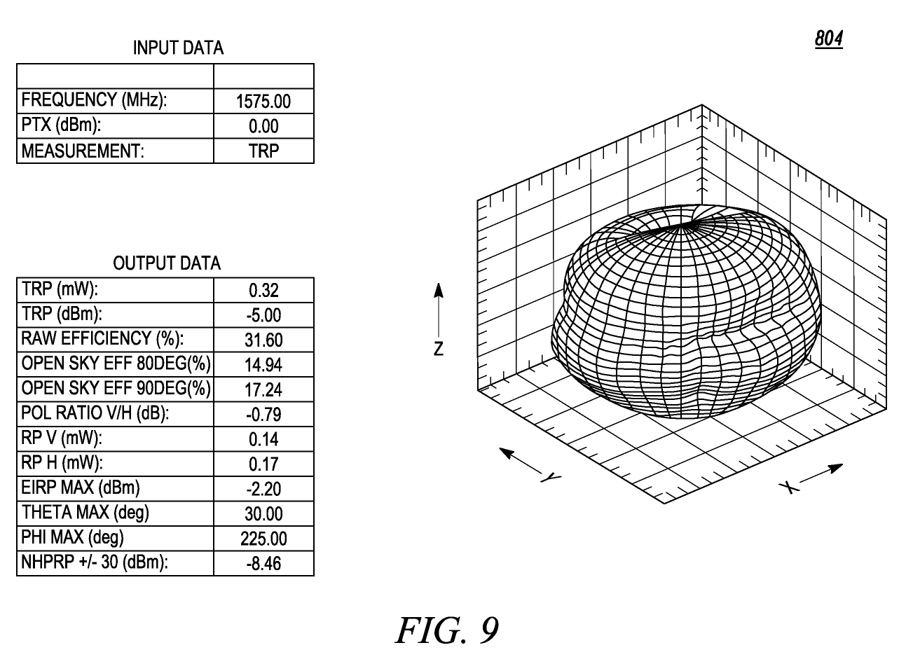

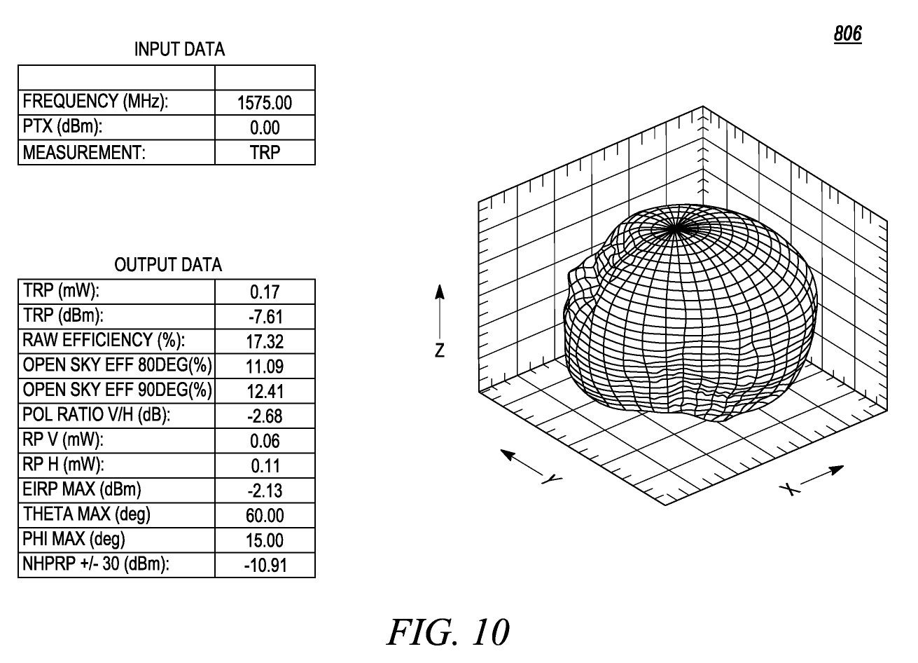

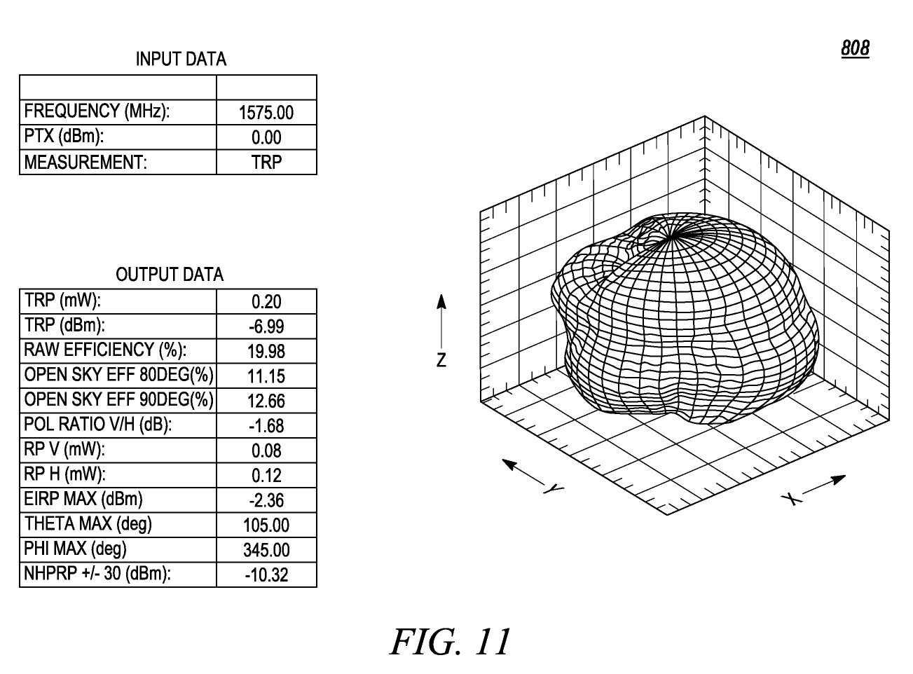

FIGS. 8 to 11 are measurements of antenna radiation patterns 802, 804, 806 and 808 generated by the antenna assembly 132 when the antenna element 136 is coupled to the speaker assembly in accordance with the present embodiment to provide increased metallization for generation of the antenna length for reception of the GPS signals. FIG. 8 is a first measurement of a radiation pattern 802 of the GPS antenna assembly 132 when the portable communication device 200 is oriented in the closed position in free space. FIG. 9 is a second measurement of a radiation pattern 804 of the GPS antenna assembly 132 when the portable communication device 200 is oriented in the open position in free space. FIG. 10 is a third measurement of a radiation pattern 806 of the GPS antenna assembly 132 when the portable communication device 200 is oriented in the closed position with a simulated human hand holding the portable communication device 200. And FIG. 11 is a fourth measurement of a radiation pattern 808 of the GPS antenna assembly 132 when the portable communication device 200 is oriented in the open position in while being held in the simulated human hand.

As can be seen from the measurements, the radiation patterns 802, 804, 806, 808, tuning the antenna assembly 132 in accordance with the present embodiment provides enhanced, robust functionality regardless of the orientation of the portable communication device 200 and regardless of whether the portable communication device 200 is handheld or in free space.

Thus it can be seen that a method and apparatus have been disclosed which advantageously provides a tunable antenna assembly design which provides robust RF reception tunable for GPS signal frequencies in both an open phone position and a closed phone position and is ideally suited for slim foldable phone form factors. While at least one exemplary embodiment has been presented in the foregoing detailed description of the invention, it should be appreciated that a vast number of variations exist. Although the embodiments tune the second antenna assembly 132 to receive GPS frequencies, the dimension of the various elements (e.g., first antenna element 136 and the loudspeaker assembly 124) and the values of the first choke 128 and second choke 130 can be varied in accordance with known tuning techniques to tune the second antenna assembly 132 to other target frequency ranges.

In addition, in this document, relational terms such as first and second, top and bottom, and the like are used solely to distinguish one entity or action from another entity or action without necessarily requiring or implying any actual such relationship or order between such entities or actions. The terms “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “includes . . . a” does not, without more constraints, preclude the existence of additional identical elements in the process, method, article, or apparatus that comprises the element.

It will also be appreciated that embodiments of the invention described in this document may include one or more conventional processors and unique stored program instructions that control the one or more processors to implement, in conjunction with certain non-processor circuits, some, most, or all of the functions of the portable communication device described (where the non-processor circuits may include an RF receiver and/or transceiver, clock circuits, power source circuits, and user input/output devices). As such, these functions may be interpreted as steps of a method to perform antenna tuning of the portable communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could also be used. Thus, antenna systems for a portable communication device in accordance with the embodiments have been described herein as well as methods and means for tuning the antenna system in accordance with the embodiments. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits with minimal experimentation.

It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A portable communication device comprising:
an antenna element; and
a metal element of a speaker assembly coupled to the antenna element to provide increased metallization for generation of an antenna length for reception of desired communication signals.

2. The portable communication device in accordance with claim 1 wherein the antenna element is capacitively coupled to the speaker assembly.

3. The portable communication device in accordance with claim 1 wherein the antenna element is integrally formed with the metal element of the speaker assembly.

4. The portable communication device in accordance with claim 1 wherein the metal element is selected from a group consisting of: a coil, a diaphragm, a frame, and one or more contact leads.

5. The portable communication device in accordance with claim 1 wherein the antenna element is pressure connected to the metal element.

6. The portable communication device in accordance with claim 1 further comprising:
a ground plane, wherein the speaker assembly is coupled to the ground plane through a first choke to provide radio frequency (RF) isolation for the speaker assembly from the ground plane.

7. The portable communication device in accordance with claim 6 wherein the speaker assembly is coupled to an audio feed from other electronic circuitry of the portable communication device through a second choke to provide radio frequency (RF) isolation for the speaker assembly from the other electronic circuitry.

8. The portable communication device in accordance with claim 6 further comprising:
a first housing portion enclosing the antenna element, the speaker assembly, and at least a portion of the ground plane;
a second housing portion; and
a hinge element for coupling the first housing portion to the second housing portion while allowing for movement of the first housing portion relative to the second housing portion such that the portable communication device can assume at least an open position and a closed position,
wherein the antenna element is coupled to the speaker assembly to provide the increased metallization when the portable communication device is in both the open position and the closed position.

9. The portable communication device in accordance with claim 1 further comprising:
a switch, wherein the antenna element is coupled to a first pole of the switch and wherein the speaker assembly is coupled to a second pole of the switch.

10. The portable communication device in accordance with claim 1 wherein the antenna element includes a clip portion, and wherein the speaker assembly generates an electromagnetic field for operatively deflecting the clip portion to couple the clip portion to the metal element.

11. The portable communication device in accordance with claim 1 wherein the antenna element includes a clip portion, and wherein the metal element is part of a diaphragm that is deflectable to a fixed position in response to one of an electromagnetic force or an electrostatic force generated by the speaker assembly.

12. The portable communication device in accordance with claim 1 wherein the antenna element is an inverted-L antenna element.

13. The portable communication device in accordance with claim 1 wherein the desired communication signals are Global Positioning System (GPS) radio frequency (RF) signals.

14. An antenna assembly comprising:
a first antenna element; and
a second antenna element coupled to the first antenna element, wherein the second antenna element comprises at least a metallic portion of a speaker assembly.

15. The antenna assembly in accordance with claim 14 wherein the first antenna element is directly connected to the second antenna element.

16. The antenna assembly in accordance with claim 14 further comprising a switch for selectably coupling the first antenna element to the second antenna element, wherein the first antenna element is connected to a first pole of the switch, and wherein the second antenna element is connected to a second pole of the switch.

17. A method for tuning an antenna assembly with a first antenna element coupleable to a second antenna element having at least a metal element of a speaker assembly, the method comprising:
coupling the first antenna element to the metal element to provide increased metallization for tuning of an antenna length of the antenna assembly for reception of communication signals within a predetermined frequency range.

18. The method in accordance with claim 17 further comprising:
determining a quality level of signals received by the antenna assembly; and
generating an antenna assembly tuning signal in response to the quality level being below a predetermined quality level,
wherein the step of coupling is in response to the antenna assembly tuning signal.

19. The method in accordance with claim 17 wherein the speaker assembly includes a coil for generating an electromagnetic field, wherein the step of coupling comprises:
generating an electromagnetic field to contact the first antenna element to the metal element.

20. The method in accordance with claim 17 wherein the speaker assembly further includes a diaphragm, and wherein the step of coupling comprises:
providing an antenna tune signal to the speaker assembly to deflect the diaphragm to a predetermined position for pressure contacting the first antenna element to the metal element.
